(19) United States
(12) Patent Application Publication
(10) Pub. No.: US 2015/0173401 A1
(43) Pub. Date: Jun. 25, 2015

(54) Extruded and Dehydrated Products for Baby Food

(71) Applicant: Diana Naturals, Antrain (FR)

(72) Inventors: Fabien Neaud, Talensac (FR); Hugues Falquerho, Betton (FR); Patrick Raphel, Eguilles (FR)

(21) Appl. No.: 14/415,191

(22) PCT Filed: Jul. 16, 2013
(86) PCT No.: PCT/EP2013/065039

§ 371 Date: Jan. 16, 2015

(30) Foreign Application Priority Data
Jul. 16, 2012 (FR) 1256855

(51) Int. Cl. A23L 1/00; A23L 1/212; A23L 1/29; A23L 1/164

(52) U.S. Cl. CPC A23L 1/0008; A23L 1/0076; A23L 1/164; A23L 1/2121; A23L 1/296; A23V 2002/00

(57) ABSTRACT

The present invention describes dehydrated crispy products containing cereal flour and products of vegetable origin (fruits and/or vegetables) and which, once rehydrated, have specific textural features. Said products can be advantageously incorporated into dehydrated food intended for persons with problems chewing, for example young children and babies. They are advantageously used as is by rehydrating same in a liquid (hot or cold), particularly in milk. They can also be incorporated into a dry hydratable food (for example a powder for a mash, or a porridge). Once brought into contact with a liquid, said products rehydrate quickly and the rehydrated products maintain an integral structure for several minutes.

The aim of the present invention is to obtain dry crispy foodstuffs containing cereals and fruits and/or vegetables, and which, when rehydrated, can be easily chewed by people who have difficulty chewing, in particular babies. These dry foodstuffs are hereinafter called “dehydrated (or dry) products of the invention.” They can be eaten directly or can be brought into contact with a liquid (cold or hot) in order to obtain the “rehydrated products of the invention,” which in the end will be eaten. The products of the invention, in particular the dehydrated products, have a particular texture that allows them to be easily chewed, and have very advantageous organoleptic properties (in terms of taste and color).

To be easily chewed, a hydrated product must have a springiness of between 30% and 50%, which is an optimal value so that its texture is soft and resists at least three chews by a baby 12 to 36 months of age. Ideally, said rehydrated product should be able to maintain said springiness for at least three minutes after hydration. Furthermore, the hydrated product should, ideally, be able to remain whole for at least 20 minutes in a liquid (cold or hot).

It has been observed that in order to be easily moistened and to acquire, once rehydrated, a texture suitable for chewing by babies, the dry product of the invention should have particular characteristics (cf. WO2012/117106). It should, in particular, have a water activity “Aw” of between 0.15 and 0.35, and should contain less than 6% water. Its density should be between 100 and 250 g/l and its dry springiness index should be between 10 and 30%. Furthermore, it is preferable that its moisture absorption capacity is high, so that it can be hydrated instantly after being brought into contact with a liquid (cold or hot).

The technical problem which gave rise to the present application was one of obtaining a dry foodstuff containing cereals and fruits and/or vegetables, having the characteristics mentioned above (in terms of density, water content, water activity, hydration capacity and springiness) and which, once rehydrated, has a springiness of between 30% and 50%, and which remains whole for at least 20 minutes after being brought into contact with a liquid (cold or hot).

The present inventors discovered that foodstuffs containing between 30 and 90% cereal flour and between 10 and 70% fruits and/or vegetables dehydrated by roller drying or by spray drying, inter alia, meet, after having undergone extrusion—cooking—expansion, all the requirements mentioned above. These products thus are perfectly suited for use in baby food.

It was noted that the rehydrated products of the invention have a texture that is crispy to the core and can thus be chewed by babies having just a few teeth, typically babies 12 months of age or older. Said products are excellent tools for teaching babies how to chew. Furthermore, as they contain cereal flour and fruits/vegetables, they are an ideal complement to infant formula, providing satiety and fiber/vitamins to babies who consume them. Lastly, in addition to said essential properties of springiness, said products have a natural luminous color, have excellent organoleptic properties, and do not agglomerate.

Patent application GB 2 428 958 (Univ Manchester Metropolitan), published in 2007, describes a method of producing a snack food wherein dehydrated fruits and vegetables are combined with flour and sugar to make extruded snacks. Said method uses co-products of citrus, pineapple or broccoli rather than the noble parts of fruits and vegetables. Furthermore, the dehydrated fruits and vegetables used in said method are obtained by osmotic dehydration, by hot air or by freeze-drying, which are known to be unable to guarantee the absence of enterobacteria in the final product.

The present Inventors, on the contrary, recommend using the noble parts of fruits and vegetables dehydrated by roller drying and/or by spray drying, which provides organoleptic, nutritional and microbiological qualities suited to the needs of young children. Furthermore, the product of the invention can be preserved for up to about 12 months, which is much longer than the products obtained by the methods of the prior art (for example, the use-by date of the snack foods of GB 2 428 958 is only 3 months).

In fact, the snack foods produced by the method of GB 2 428 958 are not at all suitable for consumption by infants due to their shape (choking hazard), their composition (they contain sugar and non-noble raw materials), and their inadequate microbiological safety.

### DESCRIPTION OF THE DRAWINGS

FIG. 1 is a diagram of the extrusion principle used to obtain the dry products of the invention.

FIG. 2 is a diagram of the texture measurement using double compression according to time.

FIG. 3 shows the change in the hydration rate of products soaked in 45° C. milk according to time.

FIG. 4 shows the change in the hardness of the products of the invention according to hydration time in 45° C. milk.

FIG. 5 shows the mean chewiness of several products of the invention according to hydration time in 45° C. milk.

FIG. 6 shows the chewiness of product “B” of the invention according to hydration time in 45° C. milk.

FIG. 7 shows the chewiness of product “C” of the invention according to hydration time in 45° C. milk.

### DETAILED DESCRIPTION OF THE INVENTION

In a first aspect, the present invention relates to an extruded dry foodstuff having a crispy texture, containing:
between 10 to 70% by weight of dehydrated vegetable product and
between 30 to 90% by weight of at least one carbohydrate ingredient,

the sum of the weights of said vegetable product and said carbohydrate ingredient representing more than 90% by weight of the total weight of said dry foodstuff.

In the context of the present invention, “vegetable product” means any food of vegetable origin which can be consumed by a human being or by an animal and, preferably, by a baby. Preferably, said vegetable product is a fruit, a vegetable, a mixture of fruits, a mixture of vegetables, or a mixture of at least one fruit and at least one vegetable.

In a preferred embodiment, said fruit is selected from the group consisting of strawberry, raspberry, apple, banana, peach, mango, blueberry, pear, apricot, blackberry, cherry, lemon, grapefruit, pineapple, papaya, plum, prune, grape and cranberry.

In another preferred embodiment, said vegetable is selected from the group consisting of carrot, spinach, pumpkin, zucchini, tomato, garden pea, green bean, broccoli, cabbage, corn, sweet potato, onion and leek.

The dry product of the invention also contains a carbohydrate ingredient. In a preferred embodiment, a carbohydrate ingredient is an ingredient that contains mostly complex carbohydrates. In an even more preferred embodiment, said ingredient is selected from the group consisting of cereal flour (in particular wheat flour, rice flour and/or corn flour), cornstarch, wheat starch, rice starch or potato starch, as well as all maltodextrins derived from said starches.

Preferably, said extruded dry foodstuff has the following characteristics:

a) Its water content is between 1 and 6%.

The water content of a product is the percentage of the total mass of a product consisting of water. It is generally determined by weighing a sample, then desiccating the sample under vacuum and/or at high temperature to evaporate the water, then reweighing the sample to determine the amount of water lost, in accordance with a procedure standardized by the Association of Official Analytical Chemists (AOAC). The water content can also be determined by chemical titration methods (Karl Fischer titration, for example), by determining mass loss on heating (also in the presence of an inert gas), or by freeze-drying. In the food industry, the so-called “Dean-Stark” method is commonly used. From the Annual Book of ASTM (American Society for Testing and Materials) Standards, the evaporable moisture content (p) in aggregate can be calculated with the following formula:

$$p = \frac{W - D}{D}$$

where W is the initial weight of the sample, and D is the weight of the dried sample.

b) Its water activity (Aw) is between 0.15 and 0.35, preferably between 0.2 and 0.3.

The Aw value of the dry product of the invention is advantageously between 0.15 and 0.35, preferably between 0.2 and 0.3. The “water activity” (“Aw”) of a product has a direct nonlinear relationship to the water content of said product, and is generally regarded as the relative moisture within said product. Said “Aw” parameter measures the vapor pressure of moisture in a hygroscopic material, at a specific temperature, and is the vapor pressure of water in the product divided by the saturated vapor pressure of water at the same temperature. It is thus expressed as follows:

Aw=p/pₛ

where p=partial pressure of water vapor in the product, and

where pₛ=partial pressure of saturated pure water vapor

Said parameter reflects the interactions of water with the product's matrix. The water activity does not represent the water (or moisture) content of the product but rather the availability of said water. In food, Aw is most often used to express the moisture available to support microbiological growth. Most bacteria need an Aw of at least 0.91, although a few osmophilic microorganisms can grow in a product having an Aw of 0.60. Water activity is thus one of the principal parameters that influence food preservation. Various techniques for measuring water activity are known today. For example, Aw can be measured in small samples hermetically sealed in a measuring compartment equipped with a moisture sensor. The HYGROMER and HYGROLYT moisture sensor probes made by ROTRONIC meet said criteria.

c) Its density is between 100 and 250 g/l.

The density of the dry product of the invention is advantageously between 100 and 250 g/l. The density of a product is generally measured by precisely evaluating the mass of the product and that of the same volume of water. Density can be determined quite simply by means of a weighing scale and a graduated container. A one-liter container is commonly used to quickly measure the density of the products of the invention.

d) Its texture (when dry) is crispy.

Advantageously, the dry product of the invention has a crispy texture. In the context of the present invention, a dry product has a “crispy texture” when its dry springiness is between 10% and 25% and its breaking load is less than 50 N under compression (using the LLOYD TA+ texture analyzer).

e) Its springiness index when hydrated after 1 minute of rehydration in a 45° C. liquid is between 30 and 50%.

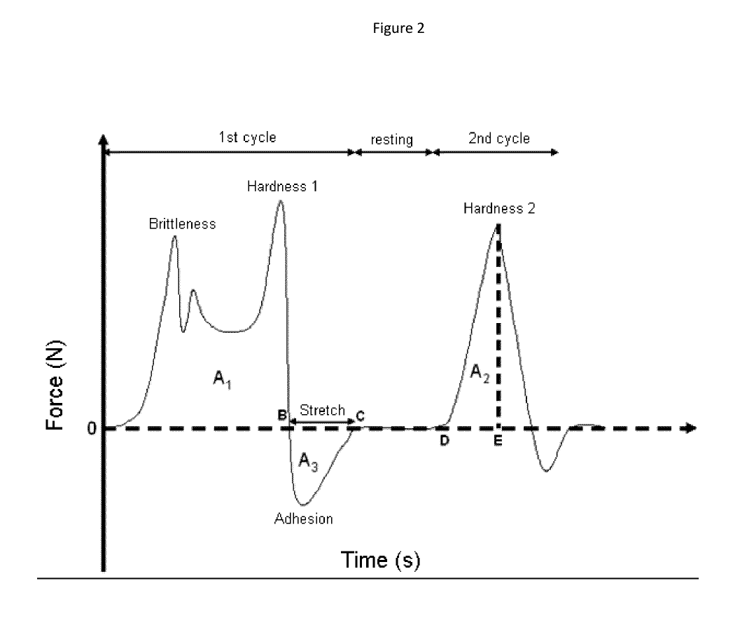

The springiness of the products of the invention can be determined by means of a texture analyzer (the TA+ texture analyzer sold by LLOYD, for example). The Nexygen software connected to the TA+ texture analyzer makes it possible to measure, via a texture analysis process, hardness, springiness, springiness index, and chewiness, inter alia, by combining two compression cycles (see FIG. 2).

Hardness represents peak force: it is the force necessary to produce the given deformation. In our case, two hardness measurements were taken, denoted H1 for the peak of the first compression and H2 for the peak of the second compression. Said value is expressed in newtons (N).

Springiness (s) is the height to which a deformed sample returns after the crushing force is removed. It is the difference between the height (h2) of the sample at the time of the second compression, minus the height (h1) of the product having undergone the first compression. Said value is expressed in millimeters (mm).

s=h2−h1

The springiness index (Iₛ) is the ratio between hardness 2 and hardness 1. It is expressed in %:

Iₛ=H2/H1, expressed in %

Advantageously, the dry product of the invention has a springiness index of between 10 and 35%. Advantageously, once hydrated for about 1 minute in a 45° C. liquid, the springiness index has a value of between 30 and 50%.

f) It can be preserved for at least 12 months under standard storage conditions (temperature around 20° C. and 60% air humidity). It hydrates instantly or gradually when brought into contact with a cold or hot liquid.

Like many extruded products, the dry products of the invention are generally not very hygroscopic and can thus be preserved for many months in suitable packaging, for example in a polyethylene bag contained in a box, without absorbing ambient moisture and without agglomerating.

g) Its chewiness is optimal after 3 to 5 minutes of hydration in a 45° C. liquid.

Chewiness (C) represents the energy required to chew a semi-solid product in order for it to be ingested. Chewiness is calculated as follows: hardness H1 multiplied by cohesion (defined as the ratio of areas A2/A1 of FIG. 2) multiplied by springiness (as defined above). It is expressed in kgf·mm or N·mm.

C=H1×A2/A×(h2−h1)

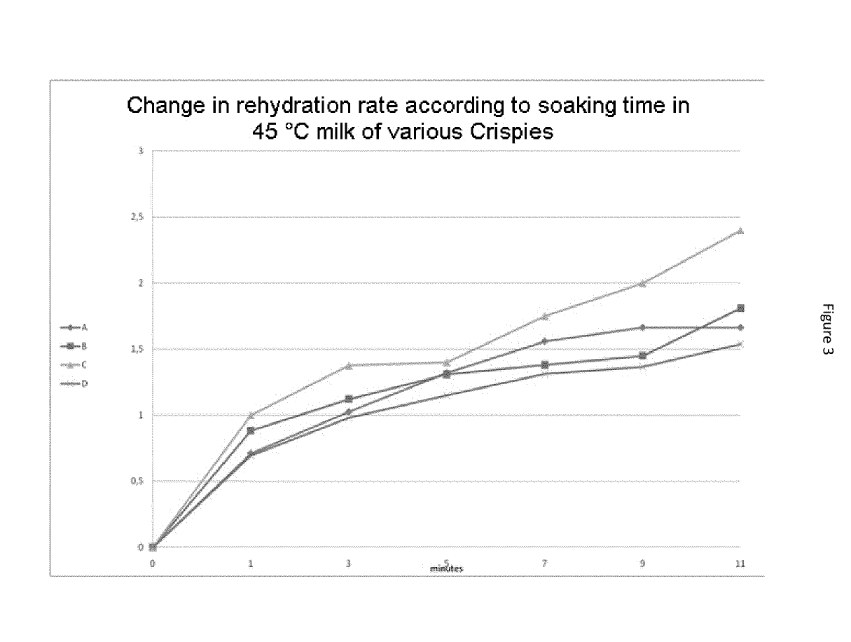

The measurement is taken during hydration in a liquid at a temperature of between 35 and 90° C., preferably of between 40 and 50° C., more preferably of 45° C. The dry product of the invention is able to hydrate instantly when it is brought into contact with a hot or cold liquid (containing water or milk, for example). Typically, the dry product of the invention can take up between 1 and 3 times its weight of milk/water after 11 minutes of hydration in the 45° C. liquid (see FIG. 3).

Advantageously, the extruded dry products of the invention have attractive properties in terms of color and shape. In particular, because they are intended for baby food, the products of the invention have, ideally:

h) A luminous color representing the fruit or vegetable, and

i) Attractive shapes: oblongs, rings, cubes, stars, rectangles, animal shapes or heterogeneous shapes (according to the extruder used).

The product of the invention is preferably not spherical in shape (beads/balls) because such shapes constitute choking hazards for children. Thus, the dry product of the invention is not extruded by means of a round die.

In a second aspect, the present invention describes a method for producing a dry foodstuff having a crispy texture, comprising the steps consisting of:
a. mixing:
   10 to 70% by weight of flakes or powder consisting of more than 40% fruit and/or vegetable, said flakes or powder having a water content of at most 5%,
   30 to 90% by weight of at least one carbohydrate ingredient having a water content of at most 15%,
wherein the sum of the weights of said flakes or said powder and said carbohydrate ingredient represents more than 90% by weight of the total weight of the mixture,
b. subjecting said mixture to cooking—extrusion,
c. expanding and shaping the extruded product,
d. drying the product obtained in step c), in a compartment heated to between 100 and 140° C., until a water content of 1 to 6% is reached,
e. cooling and final packaging.

In the context of the present invention, “flakes of a vegetable product” means small pieces of dehydrated fruits and/or vegetables (typically from 1 to 5 mm in size and in the shape of flakes). To be used in the method of the invention, said flakes should contain at least 40% vegetable and/or fruit and at most 5% water. Said flakes can be obtained by a roller drying process consisting of 1 or 2 heated cylinders or by drying under vacuum, for example. Preferably, drying is carried out on rollers.

In the context of the present invention, “powder of a vegetable product” means small solid particles (typically 100 μm to 1 mm in diameter) of dehydrated fruits or vegetables having a water content of less than 5%. Said powder can be obtained according to techniques known to persons skilled in the art such as spraying (method for dehydrating a liquid into powder form by spraying in a stream of heated air). The powder can also be produced by crushing flakes produced by roller drying or vacuum drying.

The flakes or powders used in the first step of the production method of the present invention preferably contain more than 40%, more preferably more than 75%, vegetables and/or fruits. It is also possible to use flakes or powders composed of 100% vegetables and/or fruits (i.e., containing neither additives nor support ingredients). Said flakes or powders preferably contain less than 20% additives or support ingredients, more preferably less than 10% additives or support ingredients, said additives or support ingredients being selected, for example, from starch, maltodextrin, pectin, lecithin or antioxidants.

The flakes or powders used in the first step of the production method of the present invention have a water content of at most 5%, preferably of at most 4%, and more preferably of at most 3%.

During step a), a carbohydrate ingredient obtained in a standard way is added to said vegetable products. Advantageously, said carbohydrate ingredient is selected from the group consisting of wheat flour, rice flour, corn flour, wheat starch, rice starch, cornstarch, potato starch and maltodextrins derived from said starches. Said carbohydrate ingredient should not contain more than 15% water. Preferably, it has a water content of at most 10%, more preferably it has a water content of at most 7%.

Preferably, the mixture of step a) contains between 20 and 60% by weight of said flakes or said powders of vegetable product and between 40 and 80% by weight of the carbohydrate ingredient. More preferably, said mixture contains between 20 and 40% by weight of said flakes or said powder of vegetable product and between 50 and 70% by weight of the carbohydrate ingredient. In all cases, it is important that the sum of the weights of said flakes or powders and the carbohydrate ingredient represents at least 90%, preferably at least 95%, by weight of the total weight of the mixture.

It is important to note that the mixture used in step a) of the method of the invention does not contain more than 9% by weight of any ingredient(s) other than the flakes or powder and the carbohydrate ingredient. In particular, said mixture advantageously contains only the starch naturally present in the carbohydrate ingredient or the vegetable products. An advantage of the present invention is indeed that it is not necessary to add starch or other standard texture agents exogenously, or simple sugars.

Before extrusion step b), said mixture preferably has a water content of less than 15%, more preferably a water content of less than 12%, and even more preferably a water content of between 7 and 10%, ideally of between 7% and 9%.

In a second step, the mixture obtained previously is subjected to cooking-extrusion.

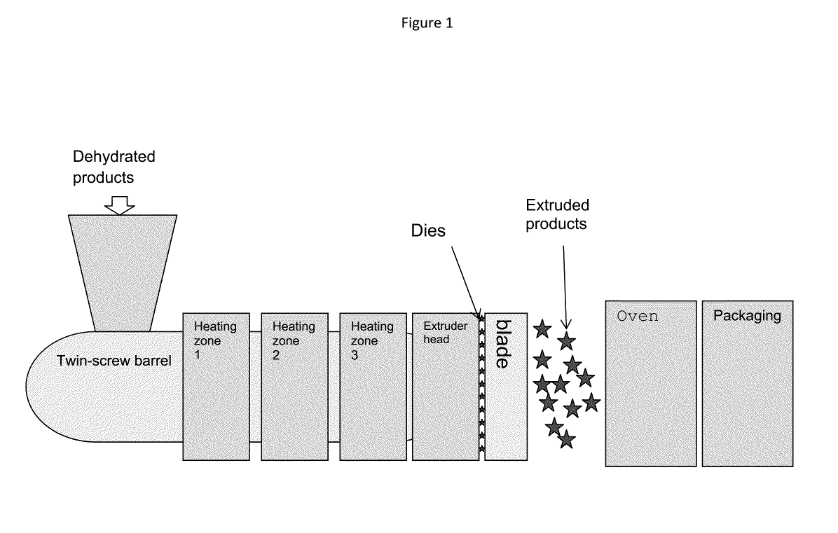

Said technique is well known to persons skilled in the art and consists in forming a product by forcing it to flow through a small opening. The extruder is fed dehydrated raw materials via one or more hoppers. Premixing can be carried out upstream in order to feed only product. The dehydrated mixture feeds the extruder. It is necessary to add water in order to hydrate the barrel and the screws and to transform the dehydrated mix into paste. Said paste will undergo high pressures and shear forces due to the rotation of the screw(s). The paste can be cooked in a controlled manner by means of various zones allowing the barrel to be heated or cooled (cf. FIG. 1). The heat produced from the heated zones and from the shear forces cooks the product and then expands it via evaporation of water upon exit from the die. The shape and size of the product are determined by the extruder head and the dies. The blade at the extruder outlet cuts the products to the desired length. On exiting the extruder the product is not yet dry and it generally finishes drying in a hot-air oven. The residence time varies according to the product and the size of the oven.

In step b) of the production method of the present invention, the extrusion can be carried out at a temperature of 80° C. to 130° C. with a barrel residence time of 10 to 40 seconds, in the presence of 15 to 25% water by weight in relation to the weight of the dehydrated feed mixture.

In a preferred embodiment, the extruded product has, after step (b), a water content of at most 15%.

Consequently, the extruded product expands by 150 to 500%. The expansion can be measured as the ratio between the lateral measurements of the expanded product.

Next, the expanded product is formed and then conveyed and dried in a heated compartment (an oven, for example) having a temperature of 100 to 140° C., until it contains a water content of at most 6%.

Finally, the product is slowly cooled in ambient air and then packaged.

It should be noted that the product of the invention does not necessarily undergo, after its extrusion expansion, a step of fractionation or of crushing. Indeed, it can advantageously be packaged directly in its extruded form.

After measuring the dry springiness index of the products of the invention using a TA+ texture analyzer, it turns out that the range of the springiness index varies, according to the product (the shape, composition and characteristics thereof), between 3% and 50%. This shows us that certain products of the invention can be consumed dry, whereas others are preferably intended to be consumed hydrated.

In a third aspect, the present invention relates to an extruded dry foodstuff obtained by the production method of the invention. Advantageously, said foodstuff has all the characteristics a) to i) mentioned above.

In a fourth aspect, the present application further relates to hydrated foodstuffs obtained by rehydrating the extruded dry foodstuffs of the invention as defined in the first and third aspects of the invention.

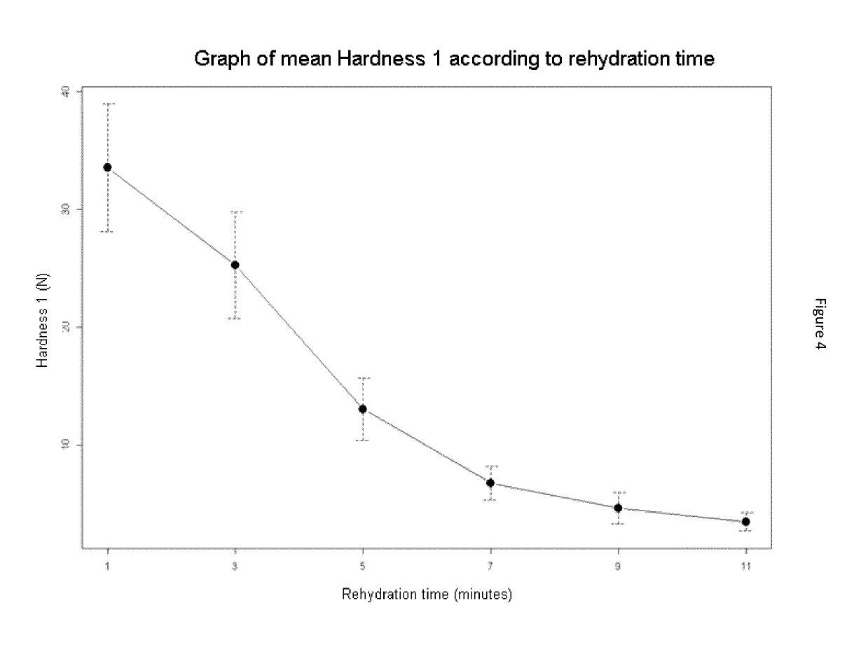

Said rehydration can take place by bringing the dry foodstuffs of the invention into contact with a liquid, such as milk, water or mixtures thereof. Said liquid can be cold (i.e., having a temperature typically between 0° C. and 8° C.) or hot (i.e., having a temperature typically between 40° C. and 90° C., preferably between 40° C. and 50° C.). As stated before, the dry products of the invention are hydrated very easily, instantly. Once the products of the invention are rehydrated, hardness 1 gradually decreases as indicated in FIG. 4. The products of the invention acquire a springiness index that is ideal for chewing by babies and young children.

More precisely, the hydrated products of the invention have a springiness index of 30 to 50% 1 minute after being brought into contact with milk or water heated to 45° C. Said springiness index corresponds to a soft, easy to chew texture which resists at least 2 chews by a 12 to 18 month old baby.

Advantageously, once brought into contact with a cold or hot liquid, the products of the invention remain whole (i.e., they maintain strong cohesion, they do not disintegrate and they remain in their initial identifiable form) for at least 15 minutes, preferably for 20 minutes, with light stirring. Advantageously, the hydrated products of the invention remain crispy to the core for at least 3 minutes after being brought into contact with a liquid heated to a temperature of 45° C.

In a fifth aspect, the present application further relates to the use of the extruded dry foodstuffs of the invention, or the hydrated foodstuffs of the invention, in food for infants, in particular in baby food.

The products of the invention can be consumed dry or hydrated.

“Baby food” means any food specially designed for young children 12 months to 3 years (36 months) of age. Since infants do not have enough teeth to chew effectively and have more difficulty swallowing, baby foods should be easy to eat, i.e., they should be sufficiently soft and not too springy so as to be easily chewed. However, they should also help the baby to develop jaw muscles and to learn how to manage solid foods with more or less firm textures.

In a preferred embodiment, the products of the invention (dry or rehydrated) are intended for food for babies 12 to 36 months of age.

In a particular embodiment, the extruded dry products of the invention are intended for food for babies 18 to 36 months of age.

In a particular embodiment, the rehydrated products of the invention are intended for food for babies 12 to 18 months of age.

As previously defined, chewiness represents the effort made by a person to chew a foodstuff.

After hydration, the average consumption time is between 1 and 11 minutes, with peak consumption between 3 and 5 minutes. It is thus necessary for the texture to be suitable during said consumption period.

Thus, if the product requires less than 1 N·mm between 3 and 5 minutes after hydration, then said product is suitable for children 12 months of age or older. In this case, the present application relates to a hydrated foodstuff obtained by rehydrating the dry foodstuff of the invention having a chewiness of less than 1 N·mm for 3 to 5 minutes after being brought into contact with a hot (45° C.) liquid, and preferably intended for children 12 months of age or older.

If the product requires more than 1 N·mm between 3 and 5 minutes after hydration, then said product is suitable for older children, for example 18 months of age or older. In this case, the present application relates to a hydrated foodstuff obtained by rehydrating the dry foodstuff of the invention having a chewiness greater than 1 N·mm for 3 to 5 minutes after being brought into contact with a hot (45° C.) liquid, and preferably intended for children 18 months of age or older.

Thus, the present invention defines two categories of products according to the targeted age of young children.

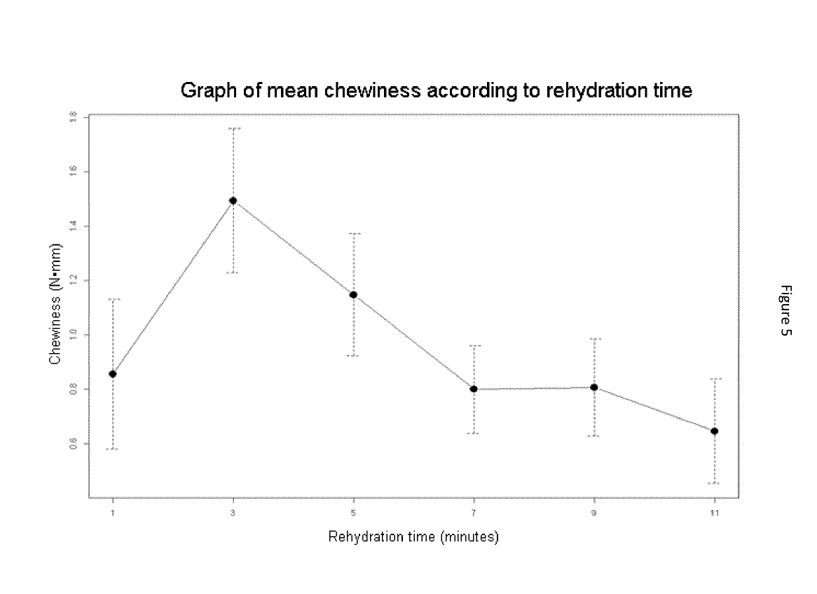

The chewiness of the products of the invention was monitored during hydration in 45° C. milk (see FIG. 5).

The optimal texture analysis parameters are:
compression rate of 50 mm/min,
compression threshold of 0.01 N,
compression of 75%.

Chewiness is not significantly a function of the shape, density or type of fruit and/or vegetable, but of a combination of all these factors.

To the extent that the dry products of the invention contain cereals and fruits/vegetables, said products can be used independently of any other food by rehydrating same extemporaneously in a cold or hot liquid. Said products indeed have the advantage of satisfying babies while providing them with vitamins, fiber and minerals due to the presence of a large quantity of fruits or vegetables. It is also possible to incorporate the dry products of the invention in dry food intended to be eaten (cereal bars, chocolates, etc.) or to be rehydrated before being eaten, such as muesli, porridge or powders for baby's cereal.

In a sixth aspect, the present application further relates to baby food containing at least one dry foodstuff of the invention. Said food is preferably selected from: muesli, porridge, powder for baby's cereal, powdered infant formula, dehydrated beverages, cereal bars or chocolates.

In a seventh aspect, the present application finally relates to baby food containing at least one hydrated foodstuff of the invention. Said food is preferably selected from: baby's cereal, porridge or infant formula.

### EXAMPLES

The extrusion tests were carried out in partnership with the company GEMEF Industries.

### Example 1

A powder mixture comprised of 30% apple flakes (containing 98% apple, 1% pectin and 1% sunflower lecithin) and 70% wheat flour is fed into a Clextral twin-screw extruder. The product is extruded and takes the form of a grain having an oblong shape with a length of 9 mm and a diameter of 4.5 mm. The product is then dried in a hot-air oven at 130° C. for 5 minutes. After drying, the product has an Aw of 0.3, 2% dry matter and a density of 100 g/l. Said product can take up more than 3 times its weight of water/milk after 11 minutes of hydration and is hydrated instantly. Said product can then be integrated in a dry cereal-based application for babies 12 to 18 months of age in a proportion of between 1 and 15% and will give an instant but consistent soft texture for 20 minutes after hydration.

The texture of said products was measured with a LLOYD TA+ connected to the Nexygen software and using its procedure for compression to rupture. Dry, the product has a springiness index of 15% and a breaking load of 10 N must be applied.

### Example 2

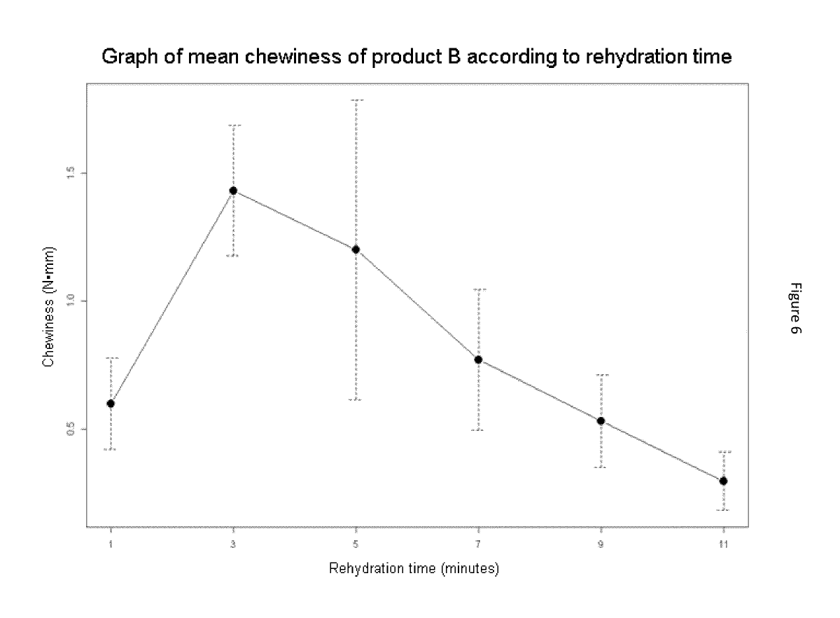

The same procedure as in example 1 was repeated with the following mixture: 63% tomato flakes (70% dehydrated tomato, cornstarch, sunflower lecithin) and 37% wheat flour. Product “B” is obtained, said product having an oblong shape of dimensions 9 mm×9 mm×5 mm and a crispy texture. The Aw is 0.25, the moisture content is 2.3%, and the density is 190 g/l. The texture of said products was measured with a LLOYD TA+ connected to the Nexygen software and using its texture analysis procedure. Dry, the product has a springiness index of 15%. After hydration in 45° C. milk, the product has a peak chewiness at 3 minutes of 1.5 N·mm which gradually decreases to 0.3 N·mm after 11 minutes of hydration (see FIG. 6). Said product requires the development of a chewing force greater than 1 N·mm and thus can be used in infant foods intended for children 18 months of age or older.

### Example 3

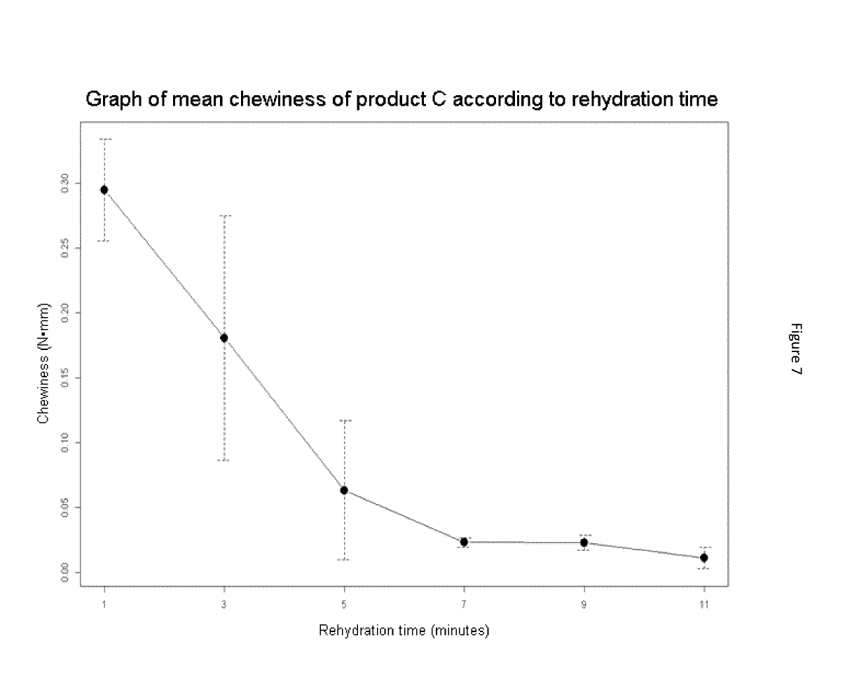

The same procedure as in example 1 was repeated while changing the die to produce a petal shape. The following mixture was transformed: 25% spinach flakes (40% dehydrated spinach, cornstarch, maltodextrin and sunflower lecithin) and 75% wheat flour. Product “C” is obtained, said product having a petal shape of dimensions 12 mm×8 mm×3 mm and a crispy texture. The Aw is 0.2, the moisture content is 2.5%, and the density is 130 g/l. The texture of said products was measured with a LLOYD TA+ connected to the Nexygen software and using its texture analysis procedure. After hydration in 45° C. milk, the product's chewiness decreases over the hydration time from 0.15 N·mm at 1 min to 0.02 N·mm (see FIG. 7). Since the chewiness of said product remains below 1 N·mm, it can thus be used in infant food intended for children 12 months of age or older.

1. Extruded dry foodstuff having a crispy texture, containing:
1. between 10 to 70% by weight of dehydrated fruits and/or vegetables, and
2. between 30 to 90% by weight of at least one carbohydrate ingredient,
the sum of the weights of said fruits and/or vegetables and said carbohydrate ingredient representing more than 90% by weight of the total weight of said dry foodstuff.

2. Extruded dry foodstuff according to claim 1, wherein the dehydrated fruits and/or vegetables are obtained by roller drying and/or by spray drying.

3. Extruded dry foodstuff according to claim 1 or 2, wherein said dehydrated fruits and/or vegetables have a mean particle size of greater than 250 μm, preferably greater than 710 μm.

4. Extruded dry foodstuff according to any one of claims 1 to 3, wherein said carbohydrate ingredient is selected from the group consisting of wheat flour, rice flour, corn flour, wheat starch, rice starch, cornstarch, potato starch and maltodextrins derived from said starches.

5. Extruded dry foodstuff according to any one of claims 1 to 4, wherein said fruit is selected from the group consisting of strawberry, raspberry, apple, banana, peach, mango, blueberry, pear, apricot, blackberry, cherry, lemon, grapefruit, pineapple, papaya, plum, prune, grape and cranberry.

6. Extruded dry foodstuff according to any one of claims 1 to 5, wherein said vegetable is selected from the group consisting of carrot, spinach, pumpkin, zucchini, tomato, garden pea, green bean, broccoli, cabbage, corn, sweet potato, onion and leek.

7. Dry foodstuff of claims 1 to 6, having a springiness index of between 3 and 50%.

8. Hydrated foodstuff obtained by rehydrating the dry foodstuff of claims 1 to 7, having a springiness index of between 30 and 50% one minute after being brought into contact with a hot liquid at 45° C.

9. Hydrated foodstuff obtained by rehydrating the dry foodstuff of claims 1 to 7, having a chewiness greater than 1 N·mm for 3 to 5 minutes after being brought into contact with a hot liquid at 45° C.

10. Hydrated foodstuff obtained by rehydrating the dry foodstuff of claims 1 to 7, having a chewiness of less than 1 N·mm for 3 to 5 minutes after being brought into contact with a hot liquid at 45° C.

11. Use of the dry foodstuff as defined in claims 1 to 7, or of the hydrated foodstuff of claims 8 to 10, in infant food.

12. Use of the dry foodstuff as defined in claims 1 to 7, in food for babies 12 to 36 months of age.

13. Use of the hydrated foodstuff of claim 8, in food for babies 12 to 36 months of age.

14. Use of the hydrated foodstuff of claim 9 in food for babies 12 months of age or older.

15. Use of the hydrated foodstuff of claim 10 in food for babies 18 months of age or older.

16. Dry baby food containing at least one dry foodstuff as defined in claims 1 to 7.

17. Hydrated baby food containing at least one hydrated foodstuff as defined in claims 8 to 10.

18. Method for producing a dry foodstuff having a crispy texture, comprising the steps consisting of:
a. mixing:
10 to 70% by weight of flakes or powder consisting of more than 40% fruit and/or vegetable, said flakes or powder having a water content of at most 5%,
30 to 90% by weight of at least one carbohydrate ingredient having a water content of at most 15%,
wherein the sum of the weights of said flakes or said powder and said carbohydrate ingredient represents more than 90% by weight of the total weight of the mixture,
b. subjecting said mixture to cooking—extrusion,
c. expanding and shaping the extruded product,
d. drying the product obtained in step c), in a compartment heated to between 100 and 140° C., until a water content of 1 to 6% is reached,
e. cooling and final packaging.

19. Method according to claim 18, wherein the dry mixture before extrusion has a moisture content of between 7 and 12%.

20. Method according to any one of claim 18 or 19, wherein said dry foodstuff is packaged in its extruded form.

21. Dry foodstuff obtained by the method according to any one of claims 18 to 20.
